(19) United States
(12) Patent Application Publication
(10) Pub. No.: US 2005/0077753 A1
(43) Pub. Date: Apr. 14, 2005

(54) Vehicle braking aerostabilizer

(76) Inventor: Donald E. Burg, Miami, FL (US)

Correspondence Address: Robert J. Van Der Wall;Colonial Bank Building, Suite 1620, 1200 Brickell Avenue, Miami, FL, 33131, US

(21) Appl. No.: 10/682,266

(22) Filed: Oct. 9, 2003

(51) Int. Cl. B62D 35/00

(52) U.S. Cl. 296/180.5

(57) ABSTRACT

Presented is a vehicle aerostabilizer(s) that is at least partially actuated by actuation forces proved by an electric motor, this actuation can cause a raising to a more vertical orientation of the aerostabilizer(s) as when the brakes are applied to result in an aerodynamic braking force being applied to the vehicle. Several options to doing this are offered including two or more aerostabilizers that may or may not rotate in concert. Much is dependent upon having an aerodynamically and weight balanced aerostabilizer(s) and limits on such balance are described. The forces to reorient the aerostabilizer(s) may be applied when the brakes of the vehicle are applied or the aerostabilizer(s) may be set, while the vehicle is underway, to a variety of orientations.

### CROSS REFERENCE TO OTHER APPLICATIONS

This application is a continuation-in-part to application Ser. No. ______ filed Sep. 26, 2003.

### BACKGROUND TO THE INVENTION

The use of aerostabilizers, more commonly called spoilers, wings, or tails, as stabilizers for vehicles has been around for many years. The idea of the aerostabilizer is to apply a downward force, generally to the rear of the vehicle, to improve stability and control. This appears to have originated from units originally applied to racing cars.

Aerostabilizers are now popular on cars and trucks, even boats in rare instances, used for everyday use. Some of the race car designs have adjustable aerostabilizers that can be adjusted from the driver's position while underway. This makes for more precise control and stability at all speeds. Some race cars have aerostabilizers that are not only adjustable but also tilt upward to a very high angle when the brakes are applied. The idea was to increase aerodynamic drag of the aerostabilizer and thereby help in braking of the vehicle. The power to run such braking units is in the form of hydraulic or pneumatic actuators due to the large forces required when the brakes are applied at high speeds.

The use of such force actuators is rather complicated and expensive. While such complication and expense can be tolerated in high cost race vehicles, it is generally prohibitive for vehicles used for everyday driving.

The instant invention presents a very low cost and simple air braking aerostabilizer. This is accomplished by use of an electric motor(s) to provide the forces to move the aerostabilizer. It is a feature of this invention that the aerostabilizer(s) be balanced about a pivot so that the forces to operate the aerostabilizer are minimized. This will be understood upon review of the following sections.

### SUMMARY OF THE INVENTION

A primary object of the invention is to provide an improved first aerostabilizer for vehicles that is capable of changing to a more vertical position when the vehicle is decelerated to thereby add an aerodynamic braking force that aids in stopping the vehicle.

A directly related object of the invention is that some type of electric motor be in communication with the first aerostabilizer to drive said aerostabilizer when the brakes are applied to the vehicle.

Yet another directly related object of the invention is that the vehicle operator may set the aerostabilizer to any position by simply adjusting an electric control means, such as a switch, to thereby move and then lock the aerostabilizer into a set orientation.

A further related object of the invention is that rotational forces of said electric motor places a biasing force on said first aerostabilizer thereby allowing said first aerostabilizer to rotate about a pivot resulting in a raising of one end of the first aerostabilizer higher than another end of said first aerostabilizer.

It is a further object of the invention that the electric motor may be an electric linear actuator motor.

It is an optional object of the invention that the electric motor may be a direct shaft output motor.

It is a further optional object of the invention that the electric motor may be a gearhead motor.

It is a related object of the invention that the term pivot may apply to a pivot that changes location by design when the aerostabilizer is changing its orientation.

Another important object of the invention is that the pivot be disposed proximal an average fore to aft mid-point of the first aerostabilizer.

An optional object of the invention is that it may include a second aerostabilizer in communication with the first aerostabilizer and wherein said second aerostabilizer moves with the first aerostabilizer.

It is a directly related object of the invention that movement of the second aerostabilizer may be in concert with the first aerostabilizer or may not be in concert as may be accomplished by using connecting levers, gears, or the like between the first and the second aerostabilizers.

A directly related object of the invention is that the pivot can be disposed within fifteen percent of a midpoint of an average fore to aft length of the first aerostabilizer.

A further related object of the invention is that the pivot can be disposed within twenty-five percent of a midpoint of an average fore to aft length of the first aerostabilizer.

Yet another related object of the invention is that the pivot be disposed within thirty-five percent of a midpoint of an average fore to aft length of the first aerostabilizer.

Another optional object of the invention is that it may further include a second aerostabilizer that is, at least partially, independent of movement of the first aerostabilizer.

A directly related object of the invention is that the pivot be disposed within fifteen percent of a midpoint of an algebraic sum of fore to aft lengths and spacings of the first and second aerostabilizers.

A further related object of the invention is that the pivot be disposed within twenty-five percent of a midpoint of an algebraic sum of fore to aft lengths and spacings of the first and second aerostabilizers.

Yet a further object of the invention is that the pivot be disposed within thirty-five percent of a midpoint of an algebraic sum of the fore to aft lengths and spacings of the first and second aerostabilizers.

Another object of the invention is that it may further comprise one or more additional aerostabilizers in communication with the first aerostabilizer and that move when the first aerostabilizer moves.

A related object of the invention is that the pivot be disposed within fifteen percent of a midpoint of an algebraic sum of the fore to aft lengths and spacings of the aerostabilizers.

Another related object of the invention is that the pivot be disposed within twenty-five percent of a midpoint of an algebraic sum of the fore to aft lengths and spacings of the aerostabilizers.

Yet another object of the invention is that pivot be disposed within thirty-five percent of a midpoint of an algebraic sum of the fore to aft lengths and spacings of the aerostabilizers.

Another optional object of the invention is that it may further include a second aerostabilizer that is, at least partially, independent of movement of the first aerostabilizer.

Yet another object of the invention is that communication means of am electric motor with the first aerostabilizer may include various connecting means.

Still another object of the invention is that communication means of said electric motor with the first aerostabilizer includes a first gear.

A related object of the invention is that communication means of said electric motor with the first aerostabilizer includes a second gear.

Yet still another object of the invention is that said electric motor be disposed, at least partially, internal to a stanchion and wherein said stanchion is disposed between the first aerostabilizer and an attachment means on the vehicle.

Still another object of the invention is that there be two stanchions disposed between the first aerostabilizer and the vehicle and that there be connecting means between the two stanchions, other than an aerostabilizer, that is disposed, at least in its majority, above stanchion attachment means on the vehicle.

A related object of the invention is that the connecting means between the two stanchions support a brake light.

### BRIEF DESCRIPTION OF THE DRAWINGS

FIG. 1 presents an perspective view showing a rear quarter of a vehicle, in this case an automobile, with the instant invention aerostabilizer. In this instance the car is traveling forward and the aerostabilizer is in its normal more horizontal orientation.

FIG. 2 presents the same perspective view of a vehicle as that given in FIG. 1 except in this case the vehicle is decelerating. Note that the aerostabilizer has tilted to a more vertical orientation to thereby add a braking aerodynamic drag force to the vehicle.

FIG. 3 is a forward quarter perspective view of the aerostabilizer only from FIG. 1. Note the low drag smooth relatively undisturbed air flow arrows over the top of the aerostabilizer.

FIG. 4 is a forward quarter perspective view of the aerostabilizer only from FIG. 2 that shows the aerostabilizer in its tilted up or braking orientation. Note the high aerodynamic drag of the aerostabilizer that is indicated by the disturbed air flow arrows over the top of the aerostabilizer that occurs when the air flow more directly impacts the aerostabilizer.

FIG. 5 presents a cross-sectional view, as taken through line 5-5 of FIG. 3 that shows a preferred embodiment of the workings of an electric drive motor. The electric drive motor in this instance is a linear actuator. This means that the shaft moves directly in or out based on the electrical command signal. In this instance the motor's shaft is withdrawn inward since the vehicle is moving forward at constant or accelerating speed and the aerostabilizer is in its lower and more horizontal orientation.

FIG. 6 is a cross-sectional view, as taken through line 6-6 of FIG. 4, that shows the motor shaft extended to thereby make the aerostabilizer go to its more vertical orientation which causes and aerodynamic braking effect. It is important to note the location of the pivot about which the aerostabilizer rotates. This pivot location should be proximal a fore to rear center of the aerostabilizer to minimize the forces required to move the aerostabilizer. This results in as small a motor as possible.

FIG. 7 present a cross-section, as taken through line 7-7 of FIG. 5, that shows the stanchion and how the linear actuator electric motor is, in this preferred embodiment of the invention, contained inside of said stanchion.

FIG. 8 is a cross-sectional view, as taken through line 8-8 of FIG. 3, that shows a similar system to that presented in FIG. 5 but with a different electric motor type. In this case a motor drives the aerostabilizer by the use of gears; however, other arrangements of a motor to drive the aerostabilizer, including having the motor recessed into the aerostabilizer itself are within the scope and spirit of the invention.

FIG. 9 presents a cross-sectional view, as taken through line 9-9 of FIG. 4, that shows position of the aerostabilizer when the vehicle is decelerating.

FIG. 10 presents a cross-section, as taken through line 10-10 of FIG. 8. This shows the electric motor and gears as they would, preferably, be positioned inside of a stanchion.

FIG. 11 shows a cross section of a first aerostabilizer showing an attachment bracket that includes a preferred location of a pivot. The A and B dimensions are equal here as they would be in the preferred embodiment of the instant invention.

It is considered workable for the pivot to be disposed within forty-five percent of the midpoint location. A range of preferred locations, as specified herein, for the location of the midpoint are: 15 percent of midpoint location, 30 percent of midpoint location, and 45 percent of midpoint location.

For example, if A+B=10 inches, then midpoint would be with A=5 inches and B=5 inches. Considering the 45 percent example biased in favor of A: A would be 5+(45%×5)=5+2.25=7.25 inches and B would be 5−(45%×5)=2.75 inches. If biased in favor of B: A=2.75 inches and B=7.25 inches. These values that locate the preferred pivot location are dependent on shape of the aerostabilizer(s), air flow characteristics to and around the aerostabilizer, and other factors. A main item of importance is to keep the aerostabilizer(s) as aerodynamically and weight balanced as possible so that the forces required to actuate it are reduced as much as possible.

FIG. 12 presents an alternative cross section showing a first and a second aerostabilizer that are connected by a bracket. In this case, the A+B measurements include the algebraic sum of A+B which includes spacings between them.

FIG. 13 gives yet another example of how a first and a second aerostabilizer might work. In this example the second aerostabilizer is fixed in position and only the moveable forward aerostabilizer is defined by the A and B measurements. Variations in the just given examples, FIGS. 11 through 13, can be made. These variations may include multiple aerostabilizers that may or may not be connected or move in unison.

### DETAILED DESCRIPTION

FIG. 1 presents a quarter rear perspective view of a vehicle 35 with a first aerostabilizer 30, including endplates 31, mount stanchions 32, and stoplight 33.

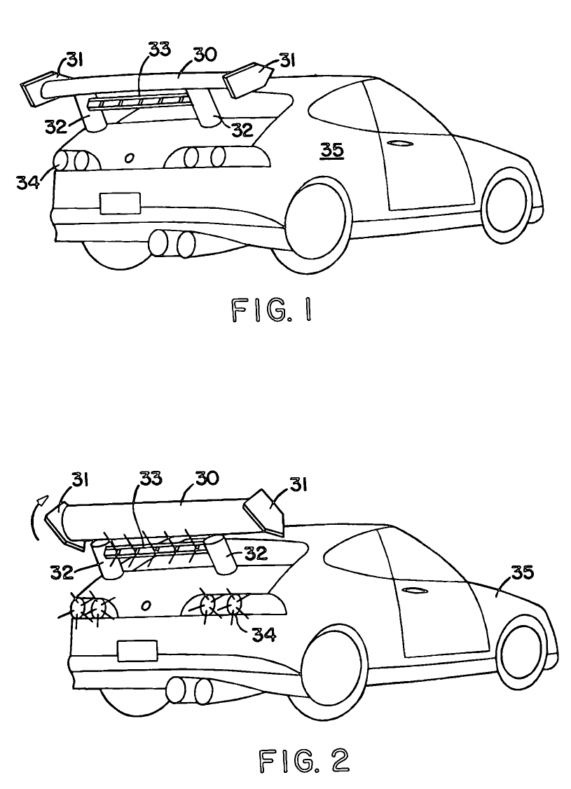

FIG. 2 is the same view of a vehicle 35 as given in FIG. 1 but in this case the vehicle 35 is decelerating and the first aerostabilizer 30 has rotated upward to thereby add an aerodynamic drag force to help slow down the vehicle 35. Note that the brake lights 33, 34 have been energized here as the brakes have been applied.

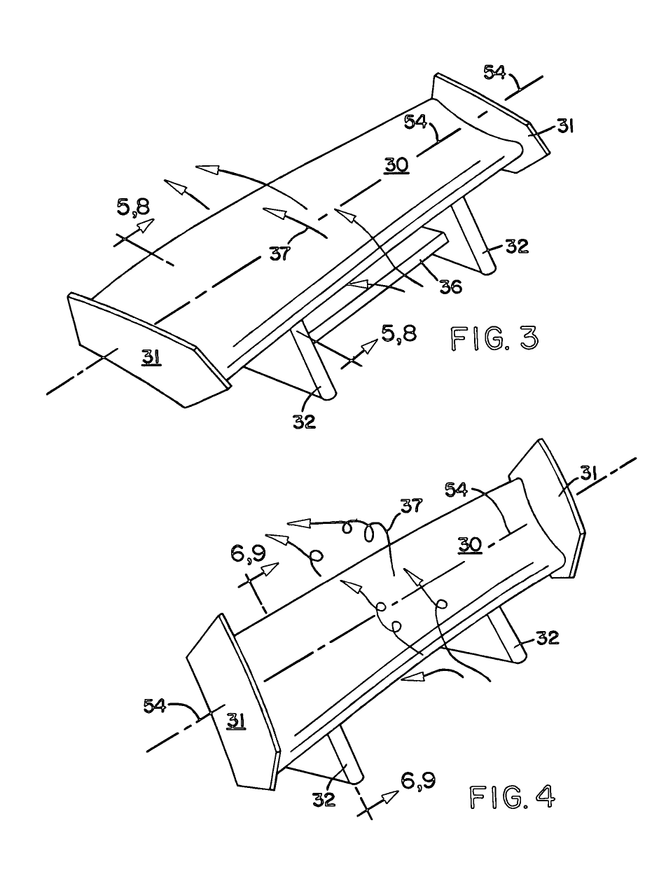

FIG. 3 is a front quarter view of the first aerostabilizer 30 of FIG. 1. The air flow arrows 37 indicate the smooth low drag of the air over the aerostabilizer in this forward non-decelerating operation of the vehicle. A connecting structure 36 may brace the stanchions 32. A longitudinal centerline 54 of the aerostabilizer 30 is also shown. The longitudinal centerline 54 may be the average of that for more than one aerostabilizer if more than one aerostabilizer is utilized.

FIG. 4 presents a front quarter view of the first aerostabilizer 30 of FIG. 2 where the vehicle 35 is decelerating because its brakes have been applied. Note the disturbed air flow over the top of the first aerostabilizer which adds to vehicle 35 drag when the vehicle 35 is decelerating.

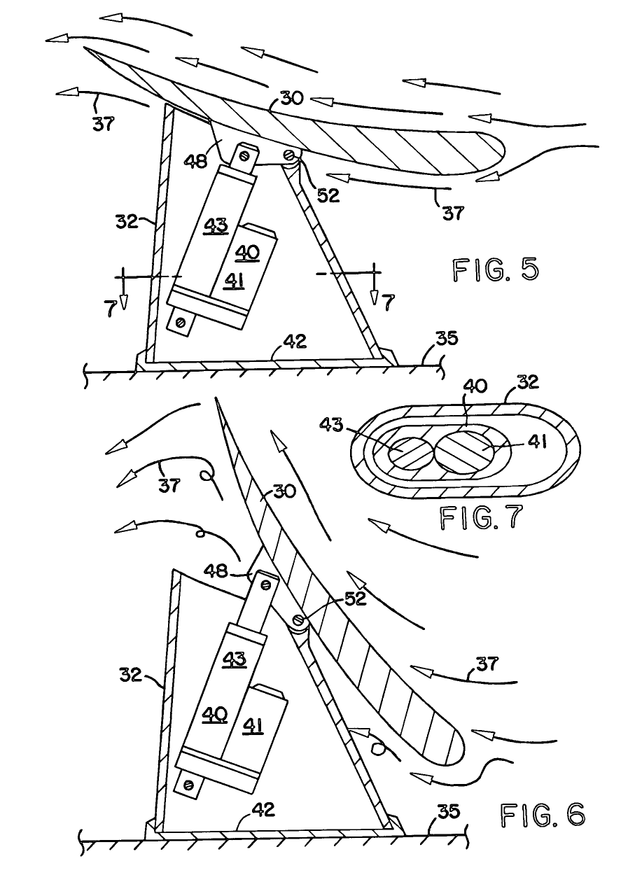

FIG. 5 presents a cross-sectional view, as taken through line 5-5 of FIG. 3, that shows the first aerostabilizer 30 in its down and low drag orientation as occurs when the vehicle 35 is traveling forward and not decelerating. Items shown include air flow arrows 37, pivot 52, electric linear actuator drive motor 40, bracket 48, and stanchion 32. The electric linear actuator motor 40 shown here includes an electric motor 41 and a linear screw drive unit 43. It is to be noted that other arrangements and types of actuator motors, not shown, may be used and are considered within the spirit and scope of the invention.

FIG. 6 gives a cross-sectional view, as taken through line 6-6 of FIG. 4, that shows the effect of decelerating the vehicle 35. Note that the shaft of the linear actuator motor is extended here. The effect of this force is to cause the first aerostabilizer 30 to move upward since it rotates about the pivot 52 to this more vertical and aerodynamic braking position.

FIG. 7 is a cross-section, as taken through line 7-7 of FIG. 5, that shows a typical way that the linear actuator motor 40 can be disposed inside of a stanchion 32.

FIG. 8 shows a cross-sectional view, as taken through line 8-8 of FIG. 3, that shows an alternate motor and mechanical arrangement to that presented in FIG. 5. In this case, a motor gear 53 and an aerostabilizer gear 49, are utilized. The motor gear 53, as driven by an electric motor 44, is in its retracted position to thereby render the aerostabilizer at its horizontal position in this FIG. 8. Note that the gears may be referred to as a first gear 53 and a second gear 49. Further, while such an arrangement is not shown, it is possible to have the drive motor 44 directly connected to the aerostabilizer adapter 48 or in other means in communication with the aerostabilizer 30.

FIG. 9 presents a cross-sectional view, as taken through line 9-9 of FIG. 4, that shows an alternate arrangement to that presented in FIG. 6. Refer to the immediately preceding discussion for the new elements. The only difference is that the aerostabilizer 30 is rotated upward since the electric drive motor 44 has applied a rotational torque.

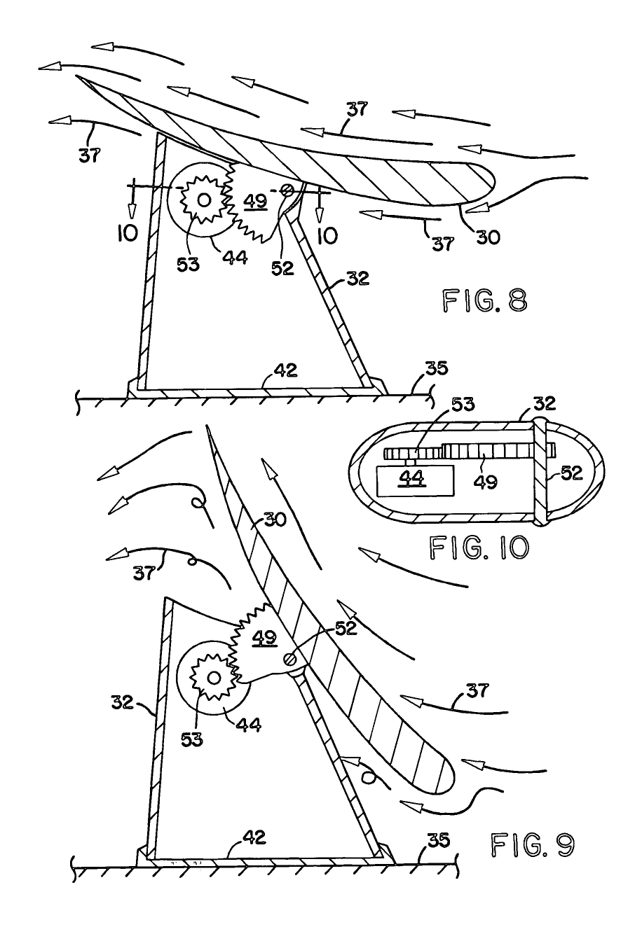

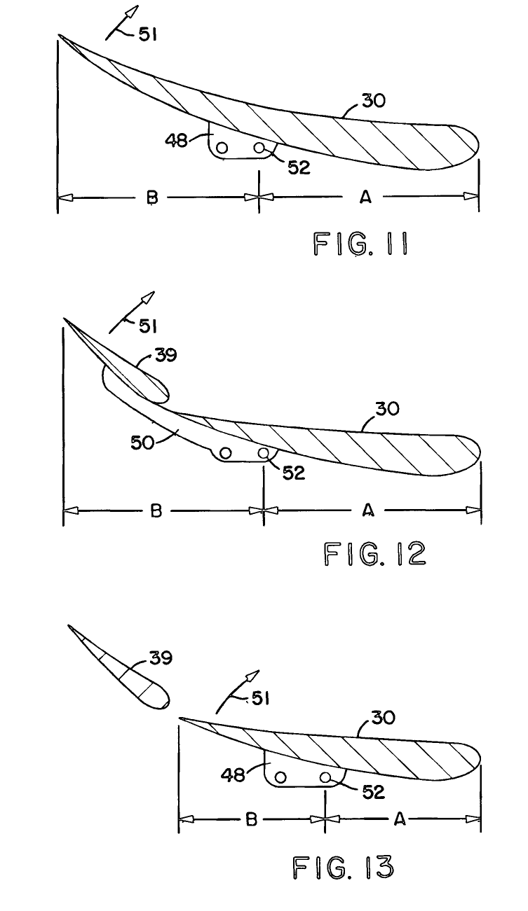

FIG. 10 present a cross-section, as taken through line 10-10 of FIG. 8. This shows the preferred arrangement of the drive motor 44, motor drive gear 53, and aerostabilizer gear 49. The drive motor 44 may contain internal gears if that is preferred and the drive motor 44 may be directly and in-line with a longitudinal axis of the aerostabilizer(s) connected to the aerostabilizer(s). While the latter arrangement is not shown, it would be a straightforward variation to the instant invention.

FIG. 11 presents a first aerostabilizer 30 and indicates where a preferred location for the pivot 52 would be disposed by use of the letters A and B. Refer to a more detailed discussion of these elements under the preceding section titled BRIEF

### DESCRIPTION OF THE DRAWINGS

FIG. 12 gives an alternative aerostabilizer to that presented in FIG. 11. In this case, a second aerostabilizer 39 has been added. It moves with the first aerostabilizer 30 since they are connected by aerostabilizer connecting bracket 50.

FIG. 13 presents another alternative for the aerostabilizer arrangements. In this instance, the first aerostabilizer 30 moves and functions as does that in FIG. 11; however, the second aerostabilizer 39 operates independently to the first aerostabilizer 30. The second aerostabilizer 39 may have a connection to the first aerostabilizer 30, may be fixed, or otherwise. It is also to be noted any number of aerostabilizers may be used and would still be considered a part of the intent of the instant invention.

While the invention has been described in connection with a preferred and several alternative embodiments, it will be understood that there is no intention to thereby limit the invention. On the contrary, there is intended to be covered all alternatives, modifications, and equivalents as may be include within the spirit and scope of the invention as defined by the appended claims, which are the sole definition of the invention.

1. In an improved first aerostabilizer for vehicles that is capable of changing to a more vertical position when the vehicle is decelerated to thereby add an aerodynamic braking force that aids in slowing down the vehicle, the improvement comprising:
a motor in communication with the first aerostabilizer wherein said motor provides an actuation force when a brake of said vehicle is applied, said actuation force causes a movement of the first aerostabilizer about a pivot resulting in a raising of one end of the first aerostabilizer higher than another end of said first aerostabilizer such that said first aerostabilizer is at a more vertical than horizontal orientation to thereby provide the aerodynamic braking force.

2-3. (canceled)

4. The improved first aerostabilizer of claim 1 wherein the pivot is disposed proximal an average fore to aft mid-point of the first aerostabilizer.

5. The improved first aerostabilizer of claim 1 wherein the pivot is disposed within fifteen percent of a midpoint of an average fore to aft length of the first aerostabilizer.

6. The improved first aerostabilizer of claim 1 wherein the pivot is disposed within thirty percent of a midpoint of an average fore to aft length of the first aerostabilizer.

7. The improved first aerostabilizer of claim 1 wherein the pivot is disposed within forty-five percent of a midpoint of an average fore to aft length of the first aerostabilizer.

8-15. (canceled)

16. The improved first aerostabilizer of claim 1 wherein the motor is powered by electricity.

17. The improved first aerostabilizer of claim 1 wherein the motor is an electric linear actuator motor.

18-19. (canceled)

20. The improved first aerostabilizer of claim 1 wherein said motor is disposed, at least in part, internal to the first aerostabilizer.

21-22. (canceled)

23. The improved first aerostabilizer of claim 1 wherein said motor is disposed, at least partially, internal to a first stanchion and wherein said first stanchion is disposed between the first aerostabilizer and an attachment means on the vehicle.

24. The improved first aerostabilizer of claim 23 which further includes a second stanchion with said first and said second stanchion in communication by a connecting structure where said connecting structure is disposed, at least primarily, below the first aerostabilizer and above the attachment means on the vehicle.

25. The improved first aerostabilizer of claim 21 wherein a vehicle stoplight is mounted to said connecting structure.

26. In an improved first aerostabilizer for vehicles that is capable of changing to a more vertical position when the vehicle is decelerated to thereby add an aerodynamic braking force that aids in slowing down the vehicle, the improvement comprising:
an electric linear actuator motor in communication with the first aerostabilizer wherein said motor provides an actuation force when a brake of said vehicle is applied, said actuation force causes a movement of the first aerostabilizer about a pivot resulting in a raising of one end of the first aerostabilizer higher than another end of said first aerostabilizer such that said first aerostabilizer is at a more vertical than horizontal orientation to thereby provide the aerodynamic braking force.

27. In an improved first aerostabilizer for vehicles that is capable of changing to a more vertical position when the vehicle is decelerated to thereby add an aerodynamic braking force that aids in slowing down the vehicle, the improvement comprising:
a motor in communication with the first aerostabilizer wherein said motor provides an actuation force when a brake of said vehicle is applied, said actuation force causes a movement of the first aerostabilizer about a pivot resulting in a raising of one end of the first aerostabilizer higher than another end of said first aerostabilizer such that said first aerostabilizer is at a more vertical than horizontal orientation to thereby provide the aerodynamic braking force.

28-29. (canceled)

30. In an improved first aerostabilizer for vehicles that is capable of changing to a more vertical position, the improvement comprising:
an electric motor in communication with the first aerostabilizer wherein said motor provides an actuation force when electric power is supplied to said electric motor to thereby provide means to adjust the orientation of the first aerostabilizer about a pivot resulting in a raising of one end of the first aerostabilizer higher than another end of said first aerostabilizer such that said first aerostabilizer is at a more vertical than horizontal orientation.

31. The improved first aerostabilizer of claim 30 wherein the pivot is disposed proximal a midpoint between fore and aft of the first aerostabilizer.

32. The improved first aerostabilizer of claim 26 wherein the pivot is disposed within thirty percent of a midpoint of an average fore to aft length of the first aerostabilizer.

33. The improved first aerostabilizer of claim 26 wherein the pivot is disposed within forty-five percent of a midpoint of an average fore to aft length of the first aerostabilizer.

34. The improved first aerostabilizer of claim 26 wherein said motor is disposed, at least partially, internal to a first stanchion and wherein said first stanchion is disposed between the first aerostabilizer and an attachment means on the vehicle.

35. The improved first aerostabilizer of claim 34 which further includes a second stanchion with said first and said second stanchion in communication by a connecting structure where said connecting structure is disposed, at least primarily, below the first aerostabilizer and above the attachment means on the vehicle.

36. The improved first aerostabilizer of claim 35 wherein a vehicle stoplight is mounted to said connecting structure.

37. The improved first aerostabilizer of claim 27 wherein the pivot is disposed proximal an average fore to aft mid-point of the first aerostabilizer.

38. The improved first aerostabilizer of claim 27 wherein the pivot is disposed within thirty percent of a midpoint of an average fore to aft length of the first aerostabilizer.

39. The improved first aerostabilizer of claim 27 wherein the pivot is disposed within forty-five percent of a midpoint of an average fore to aft length of the first aerostabilizer.

40. The improved first aerostabilizer of claim 27 wherein said motor is disposed, at least partially, internal to a first stanchion and wherein said first stanchion is disposed between the first aerostabilizer and an attachment means on the vehicle.

41. The improved first aerostabilizer of claim 40 which further includes a second stanchion with said first and said second stanchion in communication by a connecting structure where said connecting structure is disposed, at least primarily, below the first aerostabilizer and above the attachment means on the vehicle.

42. The improved first aerostabilizer of claim 41 wherein a vehicle stoplight is mounted to said connecting structure.

43. The improved first aerostabilizer of claim 30 wherein the pivot is disposed proximal an average fore to aft mid-point of the first aerostabilizer.

44. The improved first aerostabilizer of claim 30 wherein the pivot is disposed within thirty percent of a midpoint of an average fore to aft length of the first aerostabilizer.

45. The improved first aerostabilizer of claim 30 wherein the pivot is disposed within forty-five percent of a midpoint of an average fore to aft length of the first aerostabilizer.

46. The improved first aerostabilizer of claim 30 wherein said motor is disposed, at least partially, internal to a first stanchion and wherein said first stanchion is disposed between the first aerostabilizer and an attachment means on the vehicle.

47. The improved first aerostabilizer of claim 46 which further includes a second stanchion with said first and said second stanchion in communication by a connecting structure where said connecting structure is disposed, at least primarily, below the first aerostabilizer and above the attachment means on the vehicle.
